(19) United States
(12) Patent Application Publication
(10) Pub. No.: US 2006/0110968 A1
(43) Pub. Date: May 25, 2006

(54) Flexible tab for releasing an integrated circuit held within a ZIF socket

(75) Inventors: Duane Scott Miller, Wake Forest, NC (US); Harry Thomas Minikel, Raleigh, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/994,837

(22) Filed: Nov. 22, 2004

(51) Int. Cl. H01R 4/50

(52) U.S. Cl. 439/342

(57) ABSTRACT

A ZIF connector includes a cover movable between an engaged position and a disengaged position, being moved by movement of an actuator having a flexible tab attached to facilitate movement of the lever. In the engaged position, pins of an integrated circuit mounted in the ZIF connector are held in engagement with terminals within the connector. When the actuator is moved toward the disengaged position by pulling the flexible tab, the pins are released for removal of the integrated circuit from the connector. The tab may be formed from a portion of adhesive tape.

### BACKGROUND OF THE INVENTION

1. Field of the Invention

This invention relates to sockets for integrated circuits, and, more particularly, to a method for simplifying the operation of a lever used to clamp and release a circuit module within a ZIF socket.

2. Summary of the Background Art

The development of increasingly complex integrated circuits has led to circuit chips or modules, such as microprocessor chips, having large numbers of pins. For a number of reasons, many such integrated circuits are removably attached to circuit boards by means of sockets. Reasons for using sockets include a desire to be able to upgrade a system by replacing an integrated circuit or to replace a defective integrated circuit, and a need to attach an integrated circuit to a circuit board without exposing the pins extending from the integrated circuit to the temperature of a soldering process. An integrated circuit having a high pin count generally has pins arranged in a square pattern, often with a missing central portion of pins, known as a PGA (pin grid array). A mating socket for such an integrated circuit is known as a PGA socket.

The number of pins and mating terminals for a PGA integrated circuit and a mating socket is typically from 100 to over 300. Because of the number of pins involved, it is often difficult or impossible to insert the integrated circuit into the socket, or to remove the integrated circuit from the socket, if all of the electrical connections are to be made by contact deflection and broken during the insertion and removal process. This problem has largely been solved by the development of ZIF (zero insertion force) socket, which includes a movable cover through which pins from the integrated circuit to make electrical contact with spring terminals within the socket.

Such a connector typically also includes a pivotable lever, and a mechanism for converting motion of the lever to move the cover between an engaged position and a released position. In the engaged position, the cover holds the pins are against the contact terminals; in the released position, the pins are released from contact with the spring terminals, so that the integrated circuit can be easily inserted into, or removed from the socket. Usually, the lever is pivoted upward from a position in which it lies along the circuit board to move the cover into its released position for removal of the integrated circuit.

Since ZIF sockets are often placed on circuit boards that are crowded with closely packed components, it is often difficult to grasp the lever of the ZIF socket to pull it upward. There is often inadequate space to reach the lever with a finger. While a tool having a small hook may be used, it is often difficult to find a suitable tool, and it may still be difficult to use the tool without damaging the circuit board or a component, such as a decoupling capacitor, placed on the circuit board close to the lever. Thus, what is needed is a modification to the ZIF socket making the lever easy to operate without a special tool, even when other components are placed close to the lever.

The patent art includes several examples of ZIF sockets having levers particularly configured to facilitate the action of releasing an integrated circuit held within the socket. For example, U.S. Pat. Nos. 5,425,652 and 5,489,217 show ZIF sockets having levers with ends that are formed to extend upward, facilitating getting under a portion of the lever to lift it when it is lying close to the circuit board. U.S. Pat. No. 5,256,080 describes a ZIF socket with a lever having side portions extending from pivot points at each side of the socket and a cross bar extending across the front of the socket between the side portions. The cross bar further includes a handle extending forward and upward, forming a visually prominent feature that is recognizable by a consumer as being a handle. However, the ends of the levers of U.S. Pat. Nos. 5,425,652 and 5,489,217 and the handle of U.S. Pat. No. 5,256,080 do not extend upward far enough to place a gripping surface above adjacent structures, such as the integrated circuit plugged into the socket, a heat sink that may be held in place above the integrated circuit, or other components that may be attached to the circuit board adjacent the ZIF socket. If these structures were to extend upward far enough to be above such components, the lever itself would prevent placement of the circuit board as close as necessary to upwardly adjacent structures in many environments. Thus, what is needed is a flexible member extending upward from the end of the lever.

U.S. Pat. No. 5,002,499 describes a ZIF socket including two U-shaped levers pivoted at opposite ends of the socket. Each of the U-shaped levers has a pair of tabs extending outward from its open ends. Pushing down on the tabs of one of the levers moves the cover of the socket to engage the pins of the integrated circuit; pushing down on the other lever causes the cover to move to release the integrated circuit. In this way, the problems associated with having to lift a lever are eliminated. However, a more complex mechanism is needed, and the outward-extending tabs increase the space on the circuit board required for the socket. Thus, what is needed is a mechanism facilitating the use of a single lever to engage and disengage the circuit pins.

### SUMMARY OF THE INVENTION

In accordance with an aspect of the invention, a socket is provided for removably attaching a plurality of pins extending from an integrated circuit with a plurality of circuit lands within a circuit board, wherein the socket includes a holder, a cover, an actuator, and a flexible tab. The holder includes a mounting surface to extend adjacent the circuit board and a plurality of terminals disposed within the holder and extending in a first direction from the mounting surface for connection to the circuit lands within the circuit board. The cover, which is movable along the holder between an engaged position and a released position, includes a plurality of holes aligned to engage the plurality of pins, to hold the plurality of pins against the plurality of terminals as the cover is held in the engaged position, and to release the plurality of pins from contact with the terminals as the cover is moved from the engaged position to the released position. The actuator is movable in engagement with the cover to move the cover from the engaged position toward the released position as a first portion of the actuator is moved opposite the first direction. The flexible tab is attached to the first portion of the actuator to extend opposite the first direction.

The actuator may include a shaft pivotally mounted within the housing and a lever arm extending along a side of the housing in a direction perpendicular to the shaft. The first portion of the actuator, to which the flexible tab is attached, is then at an end of the lever opposite the shaft.

Preferably, the flexible tab includes a portion of tape having an adhesive layer attaching the flexible tab to the first portion of the actuator and attaching opposite ends of the tape to one another to extend from the first portion of the actuator opposite the first direction. The tape may have a thermoplastic layer and an adhesive layer, or a cloth layer and an adhesive layer.

### BRIEF DESCRIPTION OF THE DRAWINGS

FIG. 1 is a perspective view of a ZIF socket built in accordance with the invention, shown holding an integrated circuit and attached to a fragmentary portion of a circuit board;

FIG. 2 is a fragmentary cross-sectional elevation of the ZIF socket of FIG. 1, taken as indicated by section line 2-2 therein; and

FIG. 3 is a fragmentary end elevation of an actuator within the ZIF socket of FIG. 1.

### DETAILED DESCRIPTION OF THE INVENTION

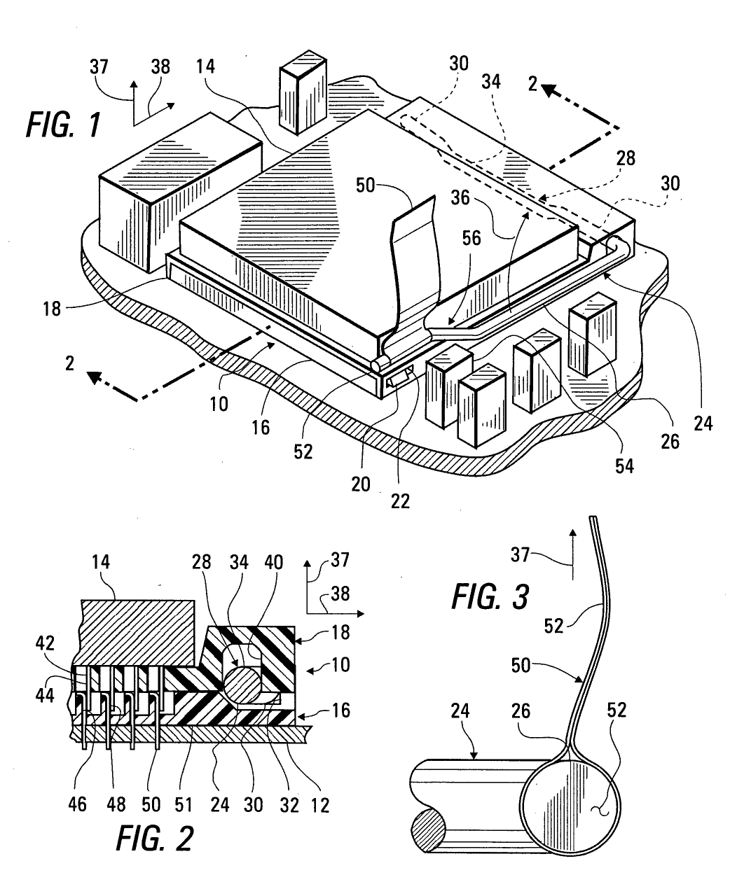

The invention will now be discussed, with particular reference being made of FIGS. 1 and 2. FIG. 1 is a perspective view of a ZIF socket 10 built in accordance with the invention, attached to a circuit board 12, holding an integrated circuit 14. FIG. 2 is a cross-sectional elevation of the socket 10 taken as indicated by section lines 2-2 in FIG. 1

The ZIF socket 10 includes a housing 16 and a cover 18, slidably mounted to the housing 16 by means of a number of tabs 20 extending from the housing 16 through slots 22 in the cover 18. The socket 10 further includes an actuator 24 having a lever arm 26 and a shaft 28. The lever arm 26 extends along a side of the housing 16 and of the cover 18 in a direction perpendicular to the shaft 28. The shaft 28 includes outer pivot portions 30 pivotally mounted in a slot 32 within the housing 16 and a central portion 34 eccentrically disposed from the pivot portions 30.

As the lever arm 26 is pivoted from the lowered position, in which it is shown, in the direction of arrow 36, the central portion 34 of the shaft 28 moves away from the circuit board, in the direction of arrow 37, and rearward, in the direction of arrow 38 within a slot 40 of the cover 18, causing the cover to move rearward, in the direction of arrow 38.

The cover 18 includes a number of holes 42, through which pins 44 of the integrated circuit 14 extend into apertures 46 within the housing 16. When the cover 18 is in the engaged position, in which it is shown, the surfaces of the holes 42 hold the pins 44 against terminals 48 within the apertures 46. The terminals 48 include soldertail portions 50, extending through a mounting surface 51 of the housing 16 lying adjacent the circuit board 12 in a first direction, opposite the direction of arrow 37, to be soldered to various circuit lands (not shown) within the circuit board 12. When the cover 18 is moved in the direction of arrow 38 into a released position, the pins 44 of the integrated circuit 14 are no longer held against the terminals 48, so that the integrated circuit 14 can be easily removed or installed.

In accordance with the invention, a flexible tab 50 is attached to the lever arm 26 near its free end 52. The flexible tab 50 is conveniently gripped to pull the lever arm 26 away from the circuit board 12, in the direction of arrow 36, releasing the integrated circuit 14 for removal.

FIG. 3 is a fragmentary end elevation of the actuator 24, showing the flexible tab 50 attached to the lever arm 26. For example, the flexible tab 50 is formed by attaching a piece of adhesive tape around the lever arm 26 with the adhesive layer of the tape facing inward to adhere to the lever arm 26 and to hold end portions 52 of the tape together to extend away from the circuit board 12, in the direction of arrow 37. The tape may be a thermoplastic film material or an adhesive tape including a cloth backing material.

Referring again to FIG. 1 the ZIF socket 10 is typically attached to a circuit board 12 having a number of components 54, such as decoupling capacitors, extending away from the circuit board 12 in close proximity to the lever arm 26. The resulting space 56 between these components 54 and the integrated circuit 14 is inadequate to allow a person desiring to release the lever arm 26 itself with his fingers. However, since the flexible tab 50 preferably extends farther away from the circuit board 12 than the adjacent components 54, the outer end of the tab 50 is easily grasped to pull the lever arm 26, to which the tab 50 is attached, in the direction of arrow 56. Additionally, since the tab 50 is flexible, the ZIF socket 10 including the tab 50 can be used in applications where other components are closely spaced from the circuit card 12 in the direction of arrow 37.

The flexible tab 50 may be colored so that it is easily seen in a somewhat dark space filled with electronic components. An explanatory marking, such as “PULL TO RELEASE.” may be printed on an outer surface of the tab 50. Even if the tab 50 is in a location in which it cannot be directly seen, it can be easily found by touch.

The flexible tab 50 may be applied to the ZIF socket 10 during the process of manufacturing the socket 10, or at any stage later, during the assembly, testing, or use of the circuit built on the circuit board 12.

While a ZIF connector 10 having an actuator 24 with a lever arm 26 and a shaft 28 including an eccentric central portion 34 has been described in detail, it is understood that an alternative mechanism, such as a cam turning with the lever arm may be used to cause the cover 18 to move with motion of the actuator.

While the invention has been described in its preferred form or embodiment with some degree of particularity, it is understood that this description has been given only by way of example, and that variations can be made without departing from the spirit and scope of the invention, as defined in the appended claims.

1. A socket for removably attaching a plurality of pins extending from an integrated circuit with a plurality of circuit lands within a circuit board, wherein the socket comprises:
a housing including a mounting surface to extend adjacent the circuit board and a plurality of terminals disposed within the housing and extending in a first direction from the mounting surface for connection to the circuit lands within the circuit board;
an actuator movable in engagement with the cover to move the cover from the engaged position toward the released position as a first portion of the actuator is moved opposite the first direction; and
a flexible tab attached to the first portion of the actuator to extend opposite the first direction.

2. The socket of claim 1, wherein
said actuator includes a shaft pivotally mounted within said housing and a lever arm extending along a side of said housing in a direction perpendicular to the shaft, and
said first portion of said actuator is at an end of the lever arm opposite the shaft.

3. The socket of claim 1, wherein said flexible tab includes a portion of tape having an adhesive layer attaching said flexible tab to said first portion of said actuator and attaching opposite ends of said tape to one another to extend from said first portion of said actuator opposite said first direction.

4. The socket of claim 3, wherein said flexible tab comprises a portion of a tape having a thermoplastic layer and an adhesive layer.

5. The socket of claim 3, wherein said flexible tape comprises a portion of a tape having a cloth layer and an adhesive layer.

6. A circuit board assembly comprising:
a circuit board including a plurality of circuit lands;
a socket attached to the circuit board, wherein the socket includes a housing, a plurality of terminals disposed within the housing and extending into the circuit board from the housing, attached to the plurality of circuit lands in the circuit board, a cover, including a plurality of holes, movable along the socket between an engaged position and a released position, and an actuator, movable in engagement with the cover to move the cover from the engaged position to the released position as a first portion of the actuator is moved away from the circuit board;
an integrated circuit, releasably attached to the socket, including a plurality of pins extending into the housing through the plurality of holes within the cover, wherein surfaces of the holes within the cover hold the plurality of pins against the plurality of terminals as the cover is held in the engaged position, and wherein the plurality of pins are released from contact with the plurality of terminals as the cover is moved from the engaged position toward the released position; and
a flexible tab attached to the first portion of the actuator to extend away from the circuit board.

7. The circuit board assembly of claim 6, wherein said flexible tab includes a portion of tape having an adhesive layer attaching said flexible tab to said first portion of said actuator and attaching opposite ends of said tape to one another to extend from said first portion of said actuator opposite said first direction.

8. The circuit board assembly of claim 7, wherein said flexible tab comprises a portion of a tape having a thermoplastic layer and an adhesive layer.

9. The circuit board assembly of claim 7, wherein said flexible tape comprises a portion of a tape having a cloth layer and an adhesive layer.

10. The circuit board assembly of claim 7, additionally comprising a component extending along said circuit board adjacent said lever, wherein said flexible tab extends farther away from said circuit board than said integrated circuit and said component extend from said circuit board.

11. The circuit board assembly of claim 7, wherein the flexible tab is attached to the first portion of the actuator before the socket is attached to the circuit board.

11. The circuit board assembly of claim 7, wherein the flexible tab is attached to the first portion of the actuator after the socket is attached to the circuit board.
